(19) United States
(12) Patent Application Publication
(10) Pub. No.: US 2026/0211420 A1
(43) Pub. Date: Jul. 23, 2026

(54) FLIGHT SUPPORT DEVICE, FLIGHT SUPPORT SYSTEM, FLYING OBJECT, AND FLIGHT SUPPORT METHOD

(71) Applicant: HITACHI, LTD., Tokyo (JP)

(72) Inventors: Hironobu YAMAKAWA, Tokyo (JP); Takahiro ITO, Tokyo (JP); Mikio BANDO, Tokyo (JP); Kimiyoshi MACHII, Tokyo (JP)

(21) Appl. No.: 19/449,639

(22) Filed: Jan. 15, 2026

(30) Foreign Application Priority Data
Jan. 17, 2025 (JP) 2025-006569

(51) Int. Cl. G05D 1/495; G05D 1/606; G05D 1/656; G05D 109/25

(52) U.S. Cl. CPC G05D 1/495; G05D 1/606; G05D 1/656; G05D 2109/254

(57) ABSTRACT

Provided are a flight support device, a flight support system, a flying object, and a flight support method that are able to stabilize the flight of a flying object to which a thing is attached. The flight support device supports the flight of the flying object to which the thing (e.g., a package) is attached. The flight path acquisition section acquires the flight path of the flying object. The wind condition acquisition section acquires wind condition information that indicates the wind conditions along the flight path. The shape acquisition section acquires shape information that indicates the shape of the thing. Determination sections determine the orientation of the flying object by using the shape information and wind condition information about the thing. The output section outputs information about the orientation of the flying object.

### CROSS-REFERENCE TO RELATED APPLICATION

The present application claims priority from Japanese application JP2025-006569, filed on July 17, 2025, the content of which is hereby incorporated by reference into this application.

### BACKGROUND

The present invention relates to a flight support device, a flight support system, a flying object, and a flight support method.

In recent years, drones, which take off and land vertically relative to a landing surface, have been increasingly implemented in society. Drones are characterized by their ability to take off and land vertically from airports by using a plurality of rotors that are rotationally driven by electric motors. In order to allow the drones to produce the advantageous effect of actively utilizing lift and reducing drag, it is demanded that a flight control method be provided to enable the drones to fly in a suitable posture in relation to relative wind direction and speed during flight.

As the flight control method, for example, a technology disclosed in International Publication WO2022/145045 may be used. International Publication WO2022/145045 states that, the nose of an aerial vehicle equipped with a wind vane/anemometer is controlled to approach a posture of directly facing the acquired relative wind direction of the aerial vehicle, and that the nose points towards direction 0 to allow the aerial vehicle to move in direction 0, for example, in no wind conditions where the relative wind to the aerial vehicle moving in direction 0 at 10 m/s blows from direction 0, and further that the nose points towards direction 1.5 because, in an environment where a crosswind is blowing from direction 3 at 10 m/s, the relative wind to the aerial vehicle moving in direction 0 at 10 m/s blows from direction 1.5.

### SUMMARY

The technology described in International Publication WO2022/145045 does not take into consideration the shape of a package attached to a drone (flying object). Therefore, there is a risk that the flight of the flying object to which a package or other thing is attached may become unstable.

In view of the above-mentioned problem, the present invention aims to provide a flight support device, a flight support system, a flying object, and a flight support method that make it possible to stabilize the flight of a flying object to which a thing is attached.

In order to achieve the above-mentioned aim, according to an aspect of the present invention, there is provided a flight support device for supporting the flight of a flying object to which a thing is attached. The flight support device includes a flight path acquisition section for acquiring a flight path of the flying object, a wind condition acquisition section for acquiring wind condition information indicating wind conditions along the flight path, a shape acquisition section for acquiring shape information indicating the shape of the thing, a determination section for determining the orientation of the flying object by using the shape information about the thing and the wind condition information, and an output section for outputting the orientation of the flying object.

The present invention makes it possible to stabilize the flight of a flying object to which a thing is attached. Problems, configurations, and advantageous effects other than those described above will become apparent from the following description of embodiments.

### BRIEF DESCRIPTION OF THE DRAWINGS

FIG. 1 is a top view illustrating an embodiment;

FIG. 2 is a front view illustrating the embodiment;

FIG. 3 is a side view illustrating the embodiment;

FIG. 4A is a flowchart illustrating the embodiment;

FIG. 4B is a continuation of the flowchart of FIG. 4A;

FIG. 5 is a table illustrating information in the embodiment;

FIG. 6 is a top view illustrating the embodiment;

FIG. 7 is a diagram illustrating the information in the embodiment;

FIG. 8 is a functional block diagram illustrating the embodiment; and

FIG. 9 is a diagram illustrating a hardware configuration of the embodiment.

### DETAILED DESCRIPTION

An embodiment of the present invention will now be described with reference to the accompanying drawings. The present embodiment aims to provide, for example, a flight support device that makes it possible to determine the optimal posture of an aerial vehicle by utilizing aerodynamic information about the aerial vehicle to which a package is attached.

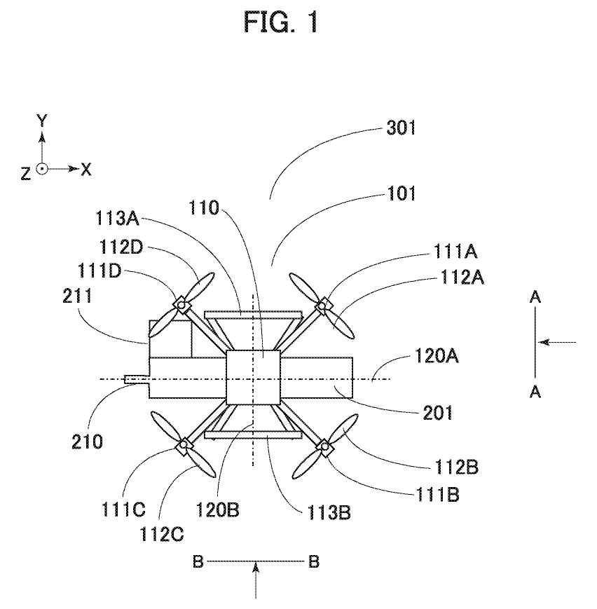

FIG. 1 is a top view of a flying object 101 according to the present embodiment. As illustrated in FIG. 1, the flying object 101 (drone) flies alone by obtaining propulsion force from the rotation of rotors 112A, 112B, 112C, 112D, which are attached to a body 110 via four arms 111A, 111B, 111C, 111D. The lower part of the body 110 is provided with support legs 113A, 113B for landing. The flying object 101 has an even number of arms 111, four in number, which are arranged symmetrically with respect to the body 110, and has a structure that is plane-symmetrical relative to the vertical plane of a main axis 120A and a sub axis 120B.

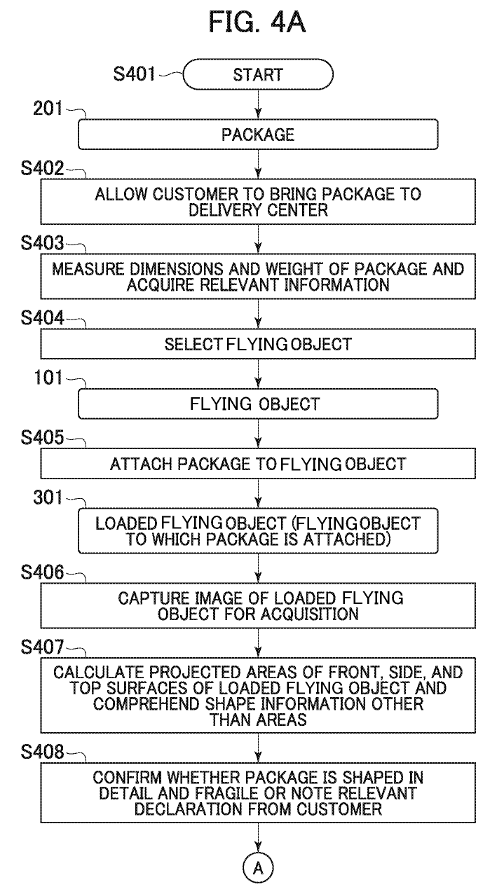

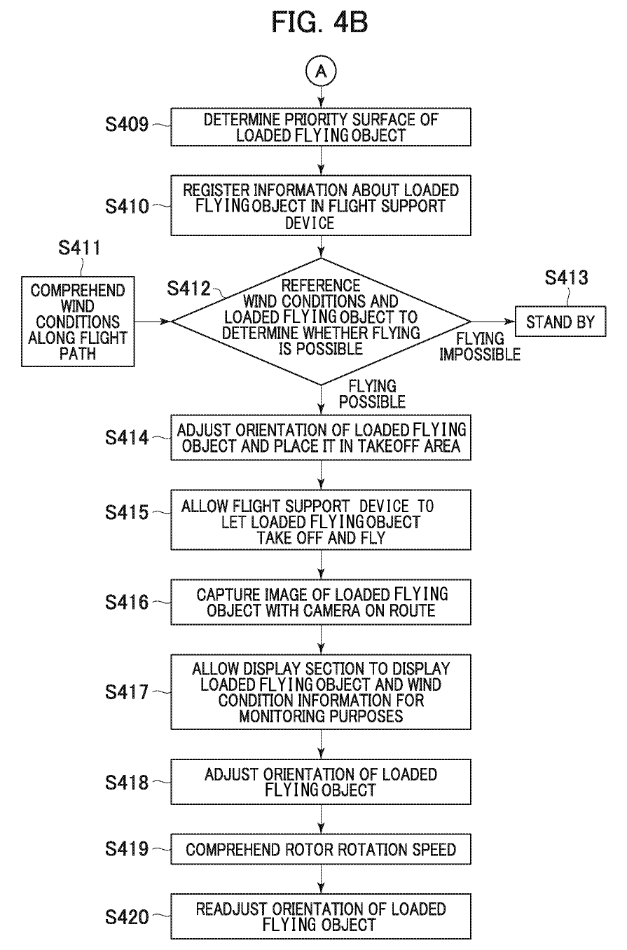

FIGS. 4A and 4B are flowcharts illustrating package delivery. As illustrated in FIGS. 4A and 4B, the package delivery starts in step S401, which is the start of a package delivery flow, and then a package 201 is brought to a delivery center as indicated in step S402. As indicated in step S403, if the dimensions and weight of the package 201 have not been measured in advance, they are measured, and at the same time, information about the package such as its fragility, which is provided from a customer, is also obtained. Next, as indicated in step S404, the weight of the package 201 is used as main information in order to select a drone, which is the flying object 101, in accordance with payload and other specifications.

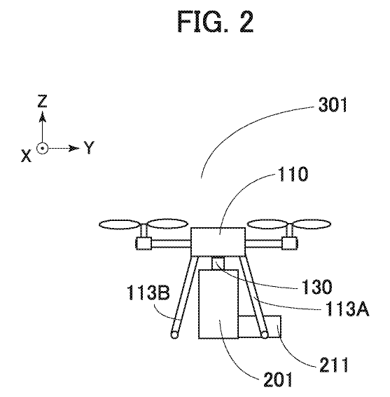

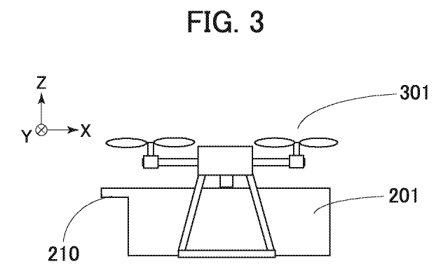

FIG. 2 is a front view as viewed from line A-A in FIG. 1. FIG. 3 is a side view as viewed from line B-B. As depicted in FIGS. 2 and 3, here, the package 201 is attached to an attachment section 130 that is provided at the bottom of the body 110 of the selected flying object 101. The package 201 is positioned approximately between the support legs 113A, 113B. The dimensions of the package 201 are longer in the direction of the main axis 120A than in the direction of the sub axis 120B, and unlike the flying object 101, the package 201 has an asymmetric shape. Further, the package 201 has a protruding stem 210 only on the rear side, which is the opposite side to the front. This stem is small in dimensions and fragile, and at the same time, valuable. Furthermore, the bottom of the package 201 is partly provided with a wide section 211, and thus the package 201 is asymmetrical with respect to the axes 120A, 120B.

The flying object 101 to which the package 201 is attached in the above-described manner is hereinafter referred to as a loaded flying object 301 that flies. The loaded flying object 301 has a more asymmetric shape than the flying object 101 alone. Additionally, when the package 201 is attached, the loaded flying object 301 as a whole has larger dimensions than the flying object 101 alone, and thus has a larger wind-catching area than the flying object 101 alone. Therefore, due to the directional dependency of the loaded flying object 301 caused by asymmetry and the increase in the wind-catching area, the aerodynamic impact (aerodynamics), which is the force that the loaded flying object 301 receives from the wind, becomes larger than when the flying object 101 flies alone. The aerodynamic impact on the flying object 101 alone is fully comprehended by flying object manufacturers so that the specifications of the flying object 101 allow a user of the flying object 101 to know the aerodynamic impact. However, the shape of the package to be delivered is not known until the user brings the package to a delivery area. Therefore, if the loaded flying object 301 is allowed to fly as is without evaluating an aerodynamic shape, the resulting flight will be unstable. Consequently, it is necessary to aerodynamically assess the loaded flying object 301.

The aerodynamic impact is often assessed by using, for example, a resistance coefficient and a lift coefficient, but can be simply assessed by determining the area of the loaded flying object 301 projected onto the top, side, and front surfaces. As indicated in step S406, the projected area can be determined by analyzing an image captured with a takeoff and landing area camera 909 installed in a takeoff and landing area. Recent image analysis technology makes it easy to extract the shape of the loaded flying object 301 and calculate its projected area.

The center of gravity of the flying object 101 alone is located relatively high up because it is located inside the body 110. In contrast, the center of gravity of the loaded flying object 301 is moved to a position lower than the case of the flying object 101 alone because the package 201 is disposed on the bottom surface of the loaded flying object 301. As a result, when stopped, the loaded flying object 301 is more stable than the flying object 101 alone. However, since thrust is obtained from the rotors 112, higher stability is achieved during flight when the center of gravity is located within the body 110, which is on roughly the same plane as the rotors 112. Therefore, aerodynamic assessment is all the more essential for the loaded flying object 301, and stable controlled flight is required.

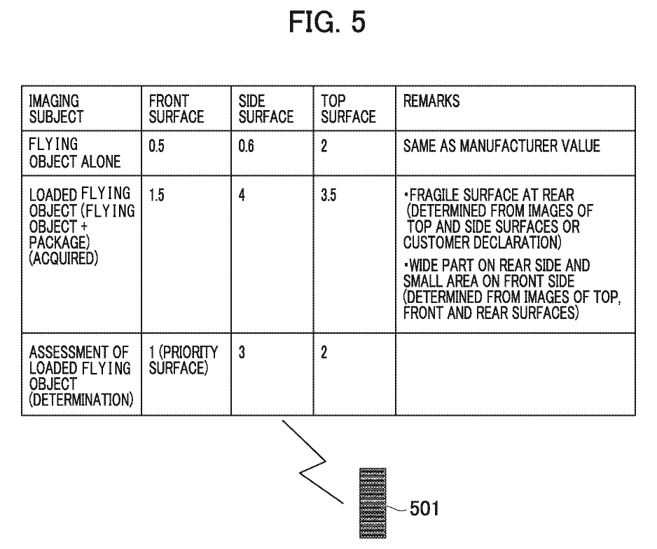

FIG. 5 is a diagram illustrating an imaging subject and the projected areas derived from images captured from the front, side, and top surfaces of the imaging subject. The projected areas are expressed in square meters. The areas of the flying object 101 alone can be determined by using the values listed in the catalog of an aerial vehicle (drone) manufacturer, and it is better to obtain such information before delivery. Even if the relevant values are not registered by the aerial vehicle manufacturer, it is advisable to obtain them yourself. If the values obtained by yourself are the same as the values provided by the aerial vehicle manufacturer, they should be written, for example, as remarks. In FIG. 5, the shape of the flying object 101 is symmetrical. Therefore, the front and side surfaces have roughly the same projected area. Meanwhile, the projected areas of the loaded flying object 301, which is formed by attaching the package 201 to the flying object 101, are all larger than those of the flying object 101 alone. Therefore, the wind-catching area is larger and the resistance from the wind is greater. The front surface has the smallest projected area and a small wind-catching area so that the resistance from the wind is small.

Further, remarks should be written, for example, to indicate that a fragile stem 210 is disposed on the rear surface, which is determined from top and side surface images. Furthermore, as a declaration from the customer requesting delivery, remarks should be written to recognize that there are fragile parts. Moreover, remarks should be written to recognize that the fact that the wide section 211 is disposed on the rear side and the area on the front side is small cannot be determined from simple projected areas, but is revealed from images captured from the top, front, and rear surfaces. From the table in FIG. 5, the direction priority of the loaded flying object 301 is determined. The surface with the smallest projected area has high priority, the fragile surface is located at the rear, and the wide section 211 has a large wind resistance. Therefore, in consideration of the fact that the area on the rear side is large and the area on the front surface is relatively small, this table determines that the front surface is the priority surface. Additionally, the next priority surface and the priority surface following the next are accordingly determined to be the top and side surfaces.

To facilitate understanding of the present embodiment, the direction of the loaded flying object 301 to which priority is assigned is in 90° increments (e.g., front and side surfaces). However, the images of all directions of the loaded flying object 301 may be captured to assign priority to any directions. In the present embodiment, the priority is determined by using (i) the projected area, (ii) the location of a valuable part of the package, and (iii) the location of a wide part. The sensitivity (weight) of variables (i)-(iii) decreases in the order of (i) to (iii) to (ii). The sensitivity of variable (ii) is the lowest due to the low frequency of bird attacks.

If no camera is available, visual inspection may be conducted for judgment purposes. In the case of visual inspection, the shape may be comprehended by using a surveillance camera 710 placed near the flight path, which will be described later, and reflected accordingly at that time.

As indicated in step S410, the information about the above-mentioned loaded flying object 301 is stored and registered in the flight support device 501, which manages the flights of various other flying objects. The flight support device 501 issues flight instructions including those for takeoff and landing of the loaded flying object 301, and also digitally manages the flight path. As indicated in step S411, wind conditions along the flight path, such as wind speed and direction, are acquired every moment for update. For example, the battery level of the loaded flying object 301 and the wind conditions along the flight path are displayed in real time to achieve safe operation.

The loaded flying object 301 whose data is registered is compared, for reference, with the wind conditions in a takeoff and landing area 601. Here, it should be noted that information about various past cases including crashes of loaded flying objects is stored in the flight support device 501. The stored information about the above-mentioned cases also include information such as the areas and specifications of the loaded flying objects, and as indicated in step S412, whether the loaded flying object 301 is able to fly safely in the future can be determined by making comparison with and referencing such stored information. If the wind conditions are severe at the time, instructions for waiting for a while are to be issued as indicated in step S413.

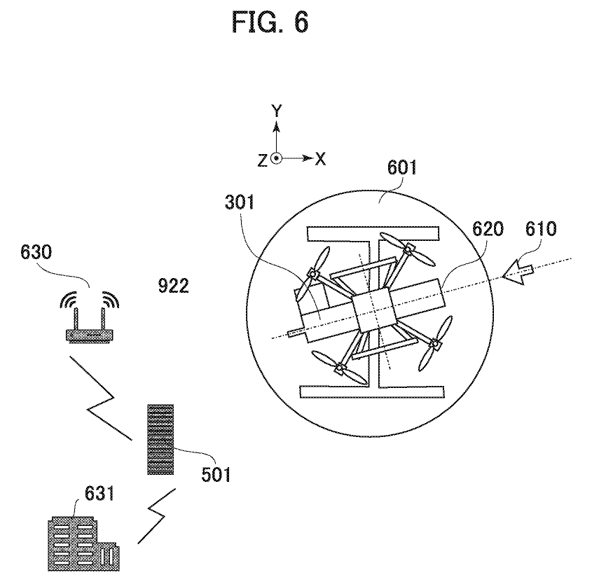

FIG. 6 is a diagram illustrating the orientation of the loaded flying object 301 at the time of takeoff. As depicted in FIG. 6, when the loaded flying object 301 is determined to be safe (flyable), it is placed in the takeoff and landing area 601 for takeoff as indicated in step S414. In this instance, the loaded flying object 301 is placed in a direction that matches a wind direction 610 in the takeoff and landing area. The wind conditions are referenced because they are stored in the flight support device 501 as information from a nearby anemometer 630 and a weather information center 631. For example, a front surface 620, which has the highest priority as indicated by the assessment results depicted in FIG. 5, is oriented to face the wind direction 610. This minimizes the aerodynamic impact from the wind, and thus enables safe takeoff.

It should be noted that any method may be used to change the orientation of the loaded flying object 301 at the time of takeoff. The orientation of the loaded flying object 301 may be changed, for example, by a human or a machine, by rotating a takeoff pad, or by controlling the loaded flying object 301 (slight ascent + rotation).

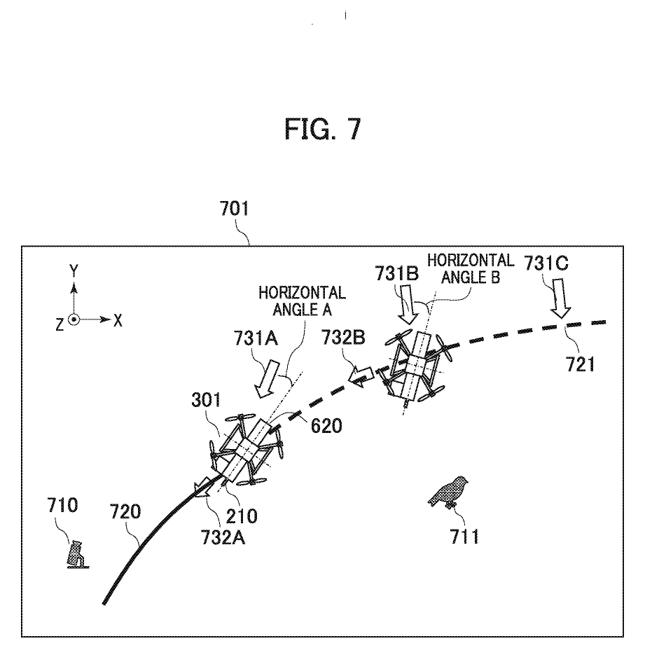

FIG. 7 is a diagram illustrating an example of information that is to be displayed on a display section 701 (display) of the flight support device 501. As depicted in FIG. 7, the display section 701 of the flight support device 501 displays the flight path. It should be noted here that the surveillance camera 710 is installed near the flight path. The surveillance camera 710 monitors, for example, other aerial vehicles and birds 711, transmits, for instance, their location information to the flight support device 501, and allows the flight support device 501 to manage and display their presence. If the image of the loaded flying object 301 cannot be captured near the takeoff and landing area, the surveillance camera 710 is used to capture such an image to acquire shape data including, for example, the area of the loaded flying object 301 and transmit the acquired shape data to the flight support device 501 for management purposes.

The displayed flight path includes a path already flown 720 and a path to be flown 721. The wind conditions for the stored flight path are displayed along the displayed flight path. Relevant winds are winds 731A, 731B, 731C along the flight path. Additionally, for example, winds 732A, 732B are generated by flying along the flight path. Since the combination of the above-mentioned winds acts on the loaded flying object 301, the flight support device 501 instructs the loaded flying object 301 to change the rotation speed of the rotors 112 and change the posture of the loaded flying object 301 in such a manner that the front surface 620, which is the priority surface, faces the above combined wind. As a result, horizontal angles A, B are generated relative to winds 731A, 731B, allowing the aerial vehicle to fly.

Further, the actual wind direction varies not only in two dimensions horizontally but also in three dimensions. Therefore, although not depicted in FIG. 7, the aerial vehicle also flies in a posture inclined in the vertical direction. Particularly, in a case where the center of gravity is changed significantly compared to the flying object alone, instability is likely to result because vertical rotation is likely to occur. In consideration of the above, sensitivity to wind direction changes in the vertical direction should be enhanced. This contributes to safe flight.

One proposal has been made to mount a wind condition sensor on the body of the aerial vehicle to control the rotor rotation speed and change its posture. However, control may not be performed in time due to a short time constant when an attempt is made to sequentially control the body of the aerial vehicle in response to the current wind speed. Additionally, even if control can be performed in time, an expensive aerial vehicle control device is required to exercise such control. In the present embodiment, certain known wind is externally controlled in accordance with already stored wind condition data. Therefore, control can be performed with a sufficient time constant so that an inexpensive aerial vehicle control device will do. Further, having a sufficient time constant makes it highly feasible to maintain posture, and thus contributes to improved safety.

As depicted in FIG. 7, the stem 210 of the package is positioned toward the rear surface and not positioned toward the front surface 620, which is at the front of the loaded flying object 301 and is prone to colliding with other aerial vehicles. Orienting the package in this manner helps protect a fragile package. Such orientation turns out to be effective in the case of, for example, a collision with a bird (bird attack). Therefore, if there is a fragile surface, registering it at the same time as registering the projected area as depicted in FIG. 5 will contribute to safe transport.

Meanwhile, the rotor rotation speed of the loaded flying object 301 is controlled and monitored at the same time by the flight support device. Therefore, in a case where the aerial vehicle is flying unsteadily or in an unnatural posture with respect to the wind direction, the rotor speed fluctuates and is monitored. Alternatively, an unstable flight may be detected by the surveillance camera. This may be due to an error in an assessed aerodynamic surface. It is probable that a selected priority surface is unfavorable for actual flight. Therefore, the priority surface is to be reset or readjusted, for example, by utilizing such rotation speed monitoring. Implementing the above-described feedback will contribute to safer flight.

A case where the package 201 is directly attached to the attachment section 130 at the bottom of the body 110 is described in conjunction with the present embodiment. However, the package 201 may also be transported by being suspended, for example, by a wire. In such a case, it is ineffective to assess the aerodynamics of the drone and the package integrated into the loaded flying object 301. In the above instance, it is sufficient to assess the drone alone, and use the specifications of the drone alone and the specifications of the package alone. However, in a case where the direction of the package is fixed relative to the body of the aerial vehicle by a wire, the present invention is appliable so that the same advantageous effects as the present embodiment are obtained.

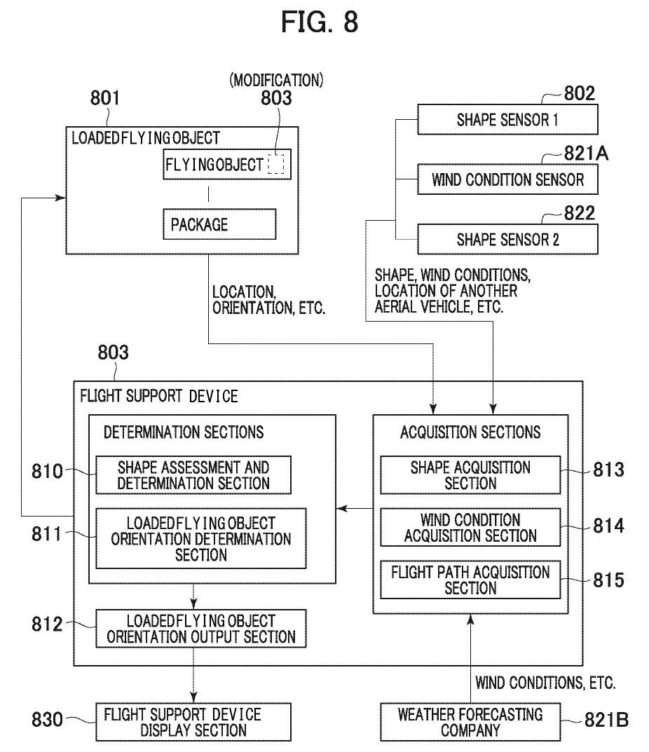

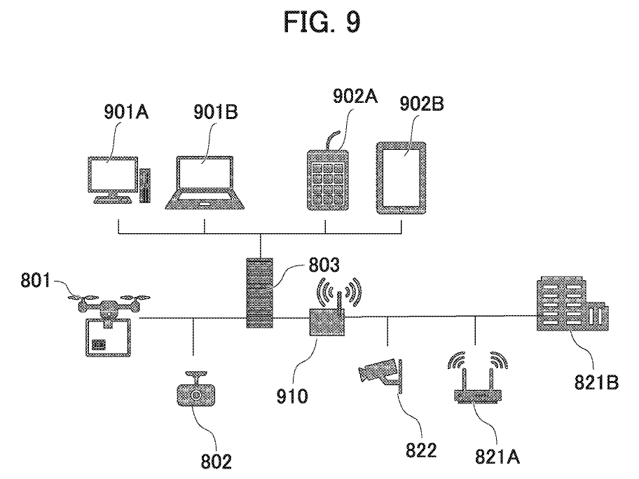

FIG. 8 is a diagram illustrating the collaboration of the various sections depicted in conjunction with the current embodiment. A shape sensor 1 (802) captures an image of a loaded flying object 801 into which the flying object and the package are integrated. A shape acquisition section 813 acquires information about the projected area and detailed shape from the shape sensor 1 (802). The acquired information is passed to a shape assessment and determination section 810. The shape assessment and determination section 810 assesses the shape in consideration of, for example, a customer declaration, and determines the surface with low aerodynamic resistance. Meanwhile, a flight path acquisition section 815 acquires the flight path in advance. For example, the flight path acquisition section 815 acquires the flight path that is inputted from a keyboard 902A (FIG. 9) by the user and stored in a storage device. However, the flight path may alternatively be acquired from the flying object. Further, a wind condition sensor 821A measures the wind conditions around the flight path. A wind condition acquisition section 814 acquires the wind conditions from the wind condition sensor 821A or a weather forecasting company 821B. Additionally, a shape sensor 2 (822) is installed near the flight path. The shape sensor 2 (822) measures the shapes and locations of other aerial vehicles (e.g., flying objects and birds) near the flight path, and additionally measures the shape and location of the loaded flying object 801 as needed. In accordance with the above information and with instructions on the orientation of the flying object, which is transmitted from a flight support device 803, the loaded flying object 801 takes off, lands, and flies. An output section 812 outputs the orientation to a flying object 803. Further, the output section 812 outputs the orientation of the flying object 803 to an administrator's display. A display section 830 displays various items of information including the information about the wind conditions. The flight support device 803 monitors the flight status of the loaded flying object 801, issues feedback flight instructions, and displays various items of information on the display section 830. The flight support device 803 may include the display section 830.

The acquisition sections acquires (receives) information about the location and orientation of the flying object (FIG. 8). For example, information about the location measured by a positioning sensor (GNSS (Global Navigation Satellite System)), which is mounted on the flying object, is transmitted from the flying object to the flight support device 803. Additionally, information about the orientation measured by a gyroscope sensor, which is mounted on the flying object, is transmitted from the flying object to the flight support device 803. The acquisition sections may estimate the orientation of the flying object from an initial value of the orientation (at takeoff) of the flying object and the progress of control. The acquisition sections acquire the locations of other aerial vehicles from the shape sensor 2 (822).

FIG. 9 is a diagram illustrating an example of the configuration of devices and other hardware used in the present embodiment. The shape sensors 1 (802) and 2 (822), which acquire information about the shape and conditions of the loaded flying object 801 into which the flying object and the package are integrated, use, for example, a plurality of digital cameras capable of capturing still images and videos or a shape measurement device equipped with a laser. The wind condition sensor 821A, such as a laser, a thermal type, a static pressure type, a streamer, or a weathervane, is used in plural numbers near the flight path. Further, data received from the weather forecasting company 821B is also referenced.

The flight support device 803 mainly includes a processor such as a central processing unit, a memory such as a RAM (Random Access Memory) or a ROM (Read Only Memory), a storage device such as a hard disk or a storage, and a communication device. Furthermore, for example, a desktop personal computer 901A and a notebook personal computer 901B are connected to the flight support device 803 and used. Moreover, since an input is required as a user interface, a keyboard 902A or a touch panel 902B may be provided. Additionally, for each device and each piece of other hardware, a wireless device 910 is used as needed to transmit the information to and from the flight support device 803.

The main features of the embodiment can be summarized as follows.

As depicted in FIG. 8, the flight support device 803 supports the flight of the flying object (loaded flying object 801) to which a thing (e.g., a package) is attached. The flight path acquisition section 815 acquires the flight path of the flying object. The wind condition acquisition section 814 acquires wind condition information that indicates the wind conditions along the flight path. The shape acquisition section 813 acquires shape information that indicates the shape of the thing. Determination sections (810, 811) determine the orientation of the flying object by using the shape information and wind condition information about the thing. The output section 812 outputs information about the orientation of the flying object. In the present embodiment, the thing is a package, but it may also be an accessory such as a camera.

Determining the orientation of the flying object by using the shape information about the thing and the wind condition information ensures that the flying object to which the thing is attached is able to fly in a posture appropriate for the shape of the thing and the wind conditions. This makes it possible to stabilize the flight of the flying object to which the thing is attached.

The determination section 810 uses the shape information about the thing to determine the priority of each orientation of the flying object (FIG. 5). The determination section 811 determines the orientation of the flying object by using the wind condition information and the information about the highest-priority orientation of the flying object (FIG. 7). As a result, the flying object to which the thing is attached can fly in a posture that is optimal for the shape of the thing and the wind conditions.

In the example in FIG. 5, the determination section 810 uses the shape information about the thing to calculate the degree of impact of wind on the flying object to which the thing is attached for each orientation of the flying object, and assigns priority so that the lower the degree of impact, the higher the priority. As a result, the flying object to which the thing is attached is able to fly in a posture that minimizes the degree of impact of wind.

The degree of impact is indicated, for example, by the projected area of the thing for each orientation of the flying object and the projected area of the flying object (FIG. 5). The degree of impact of wind can be easily calculated by using the projected areas of the thing and flying object. Alternatively, the degree of impact may be indicated by the resistance coefficient or the lift coefficient. For example, the resistance or lift coefficient is linked to shape information (template) about the thing, stored in the storage device, and the resistance or lift coefficient corresponding to the shape information about the thing measured, for example, by a camera is read from the storage device (template matching).

The determination section 810 determines the priority by using the location of the wide part of the thing (wide section 211 in FIG. 1). As a result, the location of the wide part of the thing can be reflected in the priority. In detail, the priority of the orientation of the flying object whose wide part (wide section 211 in FIG. 1) is located at the rear is higher than the priority of the orientation of the flying object whose wide part is located at the front (FIG. 5). Locating the wide part at the rear makes it possible to improve the flight stability of the flying object to which the thing is attached.

The determination section 810 determines the priority by using the location of an important part of the thing (e.g., a fragile or valuable part; stem 210 in FIG. 1). As a result, the location of an important part of the thing can be reflected in the priority. In detail, the priority of the orientation of the flying object whose important part is located at the rear is higher than the priority of the orientation of the flying object whose important part is located at the front (FIG. 5). Locating the important part at the rear makes it possible to inhibit the important part of the thing from colliding with, for example, a bird.

As depicted in FIG. 8, the acquisition sections acquire the flight path, the wind condition information, the location and orientation of the flying object, and the location of another flying object in the vicinity of the flight path as electronic information. The display section (830) displays the acquired information (FIG. 7). This enables the user to confirm the posture of the flying object and the situation around its flight path.

As depicted in FIG. 8, the acquisition sections acquire the orientation of the flying object from the flying object. The determination section 811 adjusts the orientation of the flying object by using the orientation of the flying object, which is determined by the determination section 811, and using the orientation of the flying object, which is acquired by the acquisition sections. As a result, the flying object to which the thing is attached can fly in a posture that is appropriate for the actual shape of the thing and the wind conditions.

As depicted in FIG. 8, a flight support system includes the flight support device 803 and the flying object. The flying object flies in accordance with the orientation of the flying object, which is determined by the flight support device 803. Separating the flight support device 803 from the flying object reduces the processing load on the flying object.

As indicated by the dashed line in FIG. 8, the flying object may have a built-in flight support device 803 and fly in accordance with the orientation of the flying object, which is determined by the flight support device 803. Integrating the flight support device 803 with the flying object reduces the delay in communication of a controlled variable (orientation of flying object). This results in improving the responsiveness of flying object control.

The present invention is not limited to the foregoing embodiment, but extends to various modifications. For example, the foregoing embodiment is described in detail to facilitate the understanding of the present invention, and is not necessarily limited to that having all of described component elements.

Further, for example, the above-described component elements and functions may be implemented by hardware by designing some or all of them, for instance, as an integrated circuit. Furthermore, for example, the above-described component elements and functions may be implemented by software by allowing the processor to interpret and execute programs that implement the individual functions. Programs, tables, files, and other information implementing the individual functions can be stored in a recording device such as a memory, a hard disk, and an SSD (Solid State Drive), or stored in a recording medium such as an IC card, an SD card, and a DVD.

The embodiment of the present invention may be in the following form.

### Problems Solved by Embodiment

In the future, drones are expected to be used for package transport. In such a case, it is conceivable that a package will be attached to the outside of the body of a drone such as the bottom surface of the drone. The drones are easily affected by the wind, and as aerial vehicles, they have aerodynamic properties such that they are easily affected depending their orientation and angle (posture). However, when a package is attached to a drone, its overall appearance changes significantly. This significantly changes the aerodynamic performance of the drone during flight. As regards an aerial vehicle itself, the aerodynamic properties are comprehended by the aerial vehicle manufacturer, and the payload, which is the weight of a transportable package, is also specified. However, the shape of a package varies widely so that it is difficult for the aerial vehicle manufacturer to comprehend all such different shapes. For example, asymmetric shapes formed when a package is attached to the drone are not sufficiently considered. Further, the packages to be delivered vary in size, weight, and shape. Therefore, the shape and center of gravity of the whole aerial vehicle are not determined until takeoff and landing. As a result, the aerodynamic properties are different from those of the drone alone. When the aerodynamic properties change, the air resistance experienced during flight may become higher than necessary, resulting in inefficient flight. This causes problems such as an increase in battery consumption, a decrease in flight distance, and the inability to cover a planned flight distance. Furthermore, the aerial vehicle is subjected to greater aerodynamic force than expected during flight depending on the wind conditions. This may result in an unstable flight posture and an unstable flight. Moreover, when the package is attached to the aerial vehicle, the aerodynamic force acting on the whole aerial vehicle may be too great to allow the aerial vehicle to fly. Additionally, in a case where the flight of the drone is controlled automatically, an even higher level of safety is required. Particularly, it is expected that automatic control will be implemented by digitalization of air traffic control, and for this purpose, a system capable of generating a digital model of the package on board the aerial vehicle is required.

(1) There is provided a flight support device for supporting the flight of an aerial vehicle to which a package is attached. The flight support device includes a flight path acquisition section for acquiring a flight path of the aerial vehicle, a wind condition acquisition section for acquiring wind condition information indicating wind conditions along the flight path, a shape acquisition section for acquiring shape information indicating the shape of the package attached to the aerial vehicle, a determination section for determining the orientation of the aerial vehicle by using the wind condition information and the shape information about the package, and an output section for outputting the orientation of the aerial vehicle, which is determined by the determination section. The determination section calculates the degree of impact of wind on the aerial vehicle for each orientation of the aerial vehicle to which the package is attached, and determines the orientation of the aerial vehicle that has a low degree of impact.

(2) The flight support device described in (1) acquires information about the flight path, the wind conditions, the aerial vehicle, and another aerial vehicle in the vicinity of the flight path as electronic information, and displays the acquired information.

(3) The flight support device described in (1) includes a determination section for determining the orientation of the aerial vehicle by using the shape information about the package, and an output section for outputting the orientation of the aerial vehicle, which is determined by the determination section. The determination section determines the orientation of the aerial vehicle by using feedback from the output section.

(4) The flight support device described in (1) uses information about the flight path, the wind conditions, the aerial vehicle, and another aerial vehicle in the vicinity of the flight path in order to determine whether the aerial vehicle is allowed to fly.

According to (1) to (4), the optimal posture of the aerial vehicle can be determined by utilizing the aerodynamic information about the aerial vehicle to which the package is attached.

What is claimed is:

1. A flight support device for supporting the flight of a flying object to which a thing is attached, the flight support device comprising:
a flight path acquisition section that acquires a flight path of the flying object;
a wind condition acquisition section that acquires wind condition information indicating wind conditions along the flight path;
a shape acquisition section that acquires shape information indicating the shape of the thing;
a determination section that determines the orientation of the flying object by using the shape information about the thing and the wind condition information; and
an output section that outputs the orientation of the flying object.

2. The flight support device according to claim 1,
wherein the determination section
determines the priority of each orientation of the flying object by using the shape information about the thing, and
determines the orientation of the flying object by using the orientation of the flying object having the highest priority and by using the wind condition information.

3. The flight support device according to claim 2,
wherein the determination section
uses the shape information about the thing to calculate the degree of impact of wind on the flying object to which the thing is attached for each orientation of the flying object, and
assigns the priority so that the lower the degree of impact, the higher the priority.

4. The flight support device according to claim 3,
wherein the degree of impact is indicated by the projected area of the thing for each orientation of the flying object and the projected area of the flying object.

5. The flight support device according to claim 2,
wherein the determination section
uses the location of a wide part of the thing to determine the priority.

6. The flight support device according to claim 5,
wherein the priority of the orientation of the flying object whose wide part is located at the rear is higher than the priority of the orientation of the flying object whose wide part is located at the front.

7. The flight support device according to claim 2,
wherein the determination section
uses the location of an important part of the thing to determine the priority.

8. The flight support device according to claim 7,
wherein the priority of the orientation of the flying object whose important part is located at the rear is higher than the priority of the orientation of the flying object whose important part is located at the front.

9. The flight support device according to claim 1, further comprising:
an acquisition section that acquires information about the flight path, the wind conditions, the location and orientation of the flying object, and another flying object in the vicinity of the flight path as electronic information; and
a display section that displays the acquired information.

10. The flight support device according to claim 1, further comprising:
an acquisition section that acquires the orientation of the flying object from the flying object;
wherein the determination section
adjusts the orientation of the flying object by using the orientation of the flying object, which is determined by the determination section, and using the orientation of the flying object, which is acquired by the acquisition section.

11. The flight support device according to claim 1,
wherein the thing is a package.

12. The flight support device according to claim 1,
wherein the thing is an accessory.

13. A flight support system comprising:
the flight support device according to claim 1; and
a flying object;
wherein the flying object flies in accordance with the orientation of the flying object, which is determined by the flight support device.

14. A flying object comprising:
the flight support device according to claim 1;
wherein the flying object flies in accordance with the orientation of the flying object, which is determined by the flight support device.

15. A flight support method for supporting the flight of a flying object to which a thing is attached, and causing a processor to perform a process, the method comprising:
a flight path acquisition step of acquiring a flight path of the flying object;
a wind condition acquisition step of acquiring wind condition information indicating wind conditions along the flight path;
a shape acquisition step of acquiring shape information indicating the shape the thing;
a determination step of determining the orientation of the flying object by using the shape information about the thing and the wind condition information; and
an output step of outputting the orientation of the flying object.
